(19) United States
(12) Patent Application Publication
(10) Pub. No.: US 2024/0415146 A1
(43) Pub. Date: Dec. 19, 2024

(54) METHOD FOR PRODUCING MEAT-LIKE PROCESSED FOOD

(71) Applicant: FUJI OIL HOLDINGS INC., Osaka (JP)

(72) Inventors: Tomonori SATO, Ibaraki (JP); Hiroko YONEMOTO, Ibaraki (JP)

(73) Assignee: FUJI OIL HOLDINGS INC., Osaka (JP)

(21) Appl. No.: 18/689,851

(22) PCT Filed: Sep. 13, 2022
(86) PCT No.: PCT/JP2022/034135

§ 371 Date: Mar. 6, 2024

(30) Foreign Application Priority Data
Sep. 22, 2021 (JP) 2021-154887

(51) Int. Cl. A23J 3/22; A23J 3/14

(52) U.S. Cl. CPC A23J 3/227; A23J 3/14

(57) ABSTRACT

Provided is a meat-like processed food produced using a textured plant protein material as a substitute for livestock meat without using an animal raw material, the meat-like processed food having a good yield upon heating, being rich in meat-like texture, and maintaining hardness also after being allowed to cool. The meat-like processed food without using an animal raw material can be produced by: (a) dispersing methylcellulose in an oil and/or fat; (b) swelling and dispersing a water-swellable dietary fiber in water; (c) mixing (a) and (b) to prepare an oil-in-water emulsion; (d) mixing a textured plant protein material with (c) to prepare a dough; and (e) molding the dough prepared in (d), and then heating the molded dough to produce a meat-like processed food.

### TECHNICAL FIELD

The present invention relates to a meat-like processed food produced using a textured plant protein material as a substitute for livestock meat, the meat-like processed food having a good yield upon heating, being rich in meat-like texture, and capable of maintaining hardness after being allowed to cool.

### BACKGROUND ART

The plant-based food market, particularly meat-like processed foods, such as Vegeburg, has been significantly growing at home and abroad. These meat-like processed foods are processed like livestock meat using a textured protein material produced by texturing a plant protein, such as soy protein, as a main raw material with an extruder and/or the like. However, many of such products are produced using dried egg white, which is an animal material, and thus cannot be eaten by complete vegetarians, the so-called vegans, and the like.

Methylcellulose (hereinafter MC) is frequently used as a substitute for dried egg white. Meat-like processed foods containing methylcellulose as a body are each prepared with methylcellulose, gluten, and the like in Patent Literature 1, and with an emulsion curd prepared using a soy protein isolate material and methylcellulose in Patent Literature 2. However, they have not yet established texture that can substitute for egg white. In particular, further improvements are expected for solving water syneresis upon heating and a decrease in hardness after the meat-like processed foods are allowed to cool, which are due to methylcellulose.

In Patent Literature 3, a meat-like processed food is prepared by using a lipogel in which an oil and/or fat and an insoluble fiber are combined but has different physical properties from those of hamburgers distributed in Japan, and prevention of its considerable granular feeling of meat and improvement of dry feeling are demanded.

### CITATION LIST

### Patent Literature

Patent Literature 1: JP 2005-021163 A
Patent Literature 2: JP 2018-029565 A
Patent Literature 3: JP 2018-533945 A

### SUMMARY OF INVENTION

### Technical Problem

An object of the present invention is to provide a meat-like processed food produced using a textured plant protein material as a substitute for livestock meat, the meat-like processed food having a good yield upon heating, being rich in meat-like texture, and capable of maintaining hardness after being allowed to cool.

### Solution to Problem

As a result of painstaking studies, the present inventors have found characteristics of an improved meat-like texture, an improved yield upon heating, and maintaining hardness after a meat-like processed food is allowed to cool by preparing an oil-in-water emulsion by mixing and emulsifying an oil phase in which methylcellulose is dispersed and an aqueous phase in which a water-swellable dietary fiber is swollen and dispersed in water, and adding a textured soy protein and the like to the oil-in-water emulsion to form a dough, and completed the present invention.

That is, the present invention relates to:
(1) A method for producing a meat-like processed food, the method including:
(a) dispersing methylcellulose in an oil and/or fat,
(b) swelling and dispersing a water-swellable dietary fiber in water,
(c) mixing (a) and (b) to prepare an oil-in-water emulsion,
(d) mixing a textured plant protein material with (c) to prepare a dough,
(e) molding the dough prepared in (d), and then heating the molded dough to produce a meat-like processed food;
(2) The method for producing a meat-like processed food according to (1), where the dough contains an oil-in-water emulsion gel containing methylcellulose;
(3) The method for producing a meat-like processed food according to (1) or (2), where the dough contains 0.05 to 5 wt. % of the water-swellable dietary fiber;
(4) The method for producing a meat-like processed food according to any of (1) to (3), where a water absorption amount of the water-swellable dietary fiber is 3 times or more;
(5) The method for producing a meat-like processed food according to any of (1) to (4), where the meat-like processed food is free from livestock meat and egg white.

### Advantageous Effects of Invention

According to an embodiment of the present invention, the method can provide a meat-like processed food that is rich in meat-like texture and has an improved yield upon heating and maintained hardness after being allowed to cool without using egg white.

### DESCRIPTION OF EMBODIMENTS

### Meat-Like Processed Food

A meat-like processed food in the present invention refers to a food processed like livestock meat using mainly a textured plant protein material. Examples of the meat-like processed food include hamburgers, patties, meatballs, nuggets, fish or chicken meatballs, hams, sausages, salamis, frankfurters, corn dogs, jiaozi (Chinese dumplings), shumai (Chinese steamed meat dumplings), egg rolls, meat buns, shoronpo (small Chinese dumplings), minced meat cutlets, meat pies, ravioli, lasagna, meat loaf, stuffed cabbage rolls, green peppers stuffed with meat, and other foods usually prepared using minced meat of various types.

### Oil-in-Water Emulsion

In the present invention, an oil-in-water emulsion containing methylcellulose, a water-swellable dietary fiber, and water is essential.

The methylcellulose used in the present invention is produced by methoxylation of cellulose, which is widely distributed in nature, as a raw material and is usually produced by treating cellulose with caustic soda and then reacting it with methyl chloride and an etherifying agent. In addition, it has a property of reversibly increasing the gelling power by heating. In an embodiment of the present invention, methylcellulose can be used individually or in combination with an additional gelling agent. Examples of the additional gelling agent include egg white, gellan gum, carrageenan, alginic acid, agar, curdlan, konjac flour, and starch.

An oil and/or fat of various types can be used in the emulsion of the present invention. Specific examples include soybean oil, rapeseed oil, rice oil, corn oil, palm oil, beef tallow, pork fat, and fractionated oils, hydrogenated oils, and transesterified oils of these, and these can be appropriately selected and used. However, the object of the present invention is a meat-like processed food, and thus an oil and/or fat that is in a melted state at a temperature of eating or a temperature in the mouth is desirably used.

### Water-Swellable Dietary Fiber

The water-swellable dietary fiber used in the present invention is a fiber that swells in water or warm water but does not dissolve readily in water or warm water and has a water absorption amount described below of 3 times or more. The water absorption amount is preferably 45 times or less and more preferably 40 times or less. In addition, a dietary fiber derived from a plant is preferred. Specific examples include bamboo fiber, sugarcane fiber, apple fiber, potato fiber, pea fiber, oat fiber, wheat fiber, and citrus fiber. For the effects of the present invention of being able to impart moderate hardness without drying and being able to maintain hardness also after a meat-like processed food is allowed to cool, bamboo fiber, oat fiber, and citrus fiber are particularly preferred.

The citrus fiber used in an embodiment of the present invention is produced by squeezing a citrus fruit, such as an orange, then removing juice from the squeezed liquid, and giving high impact to the cell walls after powdering. Thus, in the citrus fiber, the micellar structure of the cell is broken and becomes a porous structure. This significantly improves the water absorption capacity as well as increases the affinity with water, and consequently improves the water holding capacity for the incorporated water. A citrus raw material is particularly preferably those derived from orange and/or lemon.

The water absorption amount is measured by adding 50 g of water to 1 g of a sample fiber, stirring the mixture in a 50-mL, volume container, then allowing the mixture to stand for 24 hours, and observing the boundary between the supernatant and the precipitate. When the boundary (precipitation amount) is 20 mL., the water absorption amount is calculated to be 20 times. A sample with no observed boundary is not included in the water-swellable dietary fiber.

The water-swellable dietary fiber is added according to a procedure described below, and this improves the gel-like texture due to methylcellulose, prevents water syneresis during heating of the molded dough, and further maintains the hardness after a meat-like processed food is allowed to cool. These effects can provide a meat-like fibrous texture close to that of usual livestock meat processed food.

### Textured Plant Protein Material

The textured plant protein material used in an embodiment of the present invention is a material that has a water-insoluble tissue with directionality and is mainly composed of plant protein. Specific examples include those produced by processing a plant raw material into a textured form, the plant raw material exemplified by soybean, defatted soybean, soy protein isolate, soy protein concentrate, wheat, wheat protein, pea, pea protein, chickpea, and mycoprotein. Examples of the textured plant protein material processed from soybean include materials in the form, such as granules, flakes, or slice-formed, produced by blending soybean, defatted soybean, soy protein isolate, and/or the like together with an additional raw material if necessary, and texturing under high temperature and high pressure using a single-screw or twin-screw extrusion machine (extruder) and/or the like. Also, for pea, mung bean, or chickpea, the textured material can be produced by applying a similar treatment to a fraction containing a large amount of protein, such as a fractionated product, used as a raw material. These raw materials have a protein concentration preferably of 50 wt. % or more and more preferably of 60 wt. % or more.

For an embodiment of the present invention, a textured soy protein material containing soybean as a main raw material is suitable, and a product with any shape and size can be appropriately selected and used according to a desired product form. Although some products are distributed after rehydration, a dry product (water content 10 wt. % or less) is desirably used in an embodiment of the present invention. In addition, a soybean material textured by pressing tofu is also suitable for an embodiment of the present invention.

What is called a gluten chip or the like prepared by processing wheat protein can also be used as the textured plant protein material in an embodiment of the present invention.

The textured plant protein material and an additional material are added to the emulsion described above, and this is formed into a dough. This dough is heated, and this binds the textured plant protein material by the gelling agent mainly composed of methylcellulose and can prepare a meat-like processed food. These meat-like processed foods have a texture similar to that of a meat-like processed food produced using egg white.

### Step (a): Preparation of Methylcellulose Dispersion

Methylcellulose is dispersed in an oil and/or fat to prepare a methylcellulose dispersion. At this time, applying shear using a mixer, a food processor, a silent cutter, a hand blender, a Stephan mixer, or the like (hereinafter referred to as “the mixer or the like”) makes the dispersed particles smaller and is preferred. For the formulation, the amount of the oil and/or fat in a dough described below is preferably from 1 to 16 wt. % and more preferably from 2 to 12 wt. %. It is necessary that Methylcellulose be provided in an amount sufficient to form a gel, and the amount is exemplified by from 0.2 to 3 wt. %.

### Step (b): Preparation of Water-Swellable Dietary Fiber Dispersion

The water-swellable dietary fiber is mixed with water and swelled and dispersed to prepare a water-swellable dietary fiber dispersion. The swelling means that the fibers are hydrated and the volume of the fibers is increased, and a state in which stirring or the like is performed to prevent localization of these fibers is dispersion. At this time, applying shear using the mixer or the like described above makes the dispersed particles smaller and is preferred. For the formulation, the amount of water in a dough described below is preferably from 5 to 35 wt. % and more preferably from 10 to 30 wt. % although the amount of water changes depending on the amount of an additional additive. The amount of the water-swellable dietary fiber in a dough is preferably of 0.05 to 5 wt. %, more preferably of 0.1 to 4 wt. %, and most preferably of 0.5 to 3 wt. %. The solubility of methylcellulose described above increases at low temperatures, and thus water to be used is preferably water at a low temperature, and ice water is more preferably used.

### Step (c): Emulsion Preparation

The methylcellulose dispersion (oil phase) of step (a) and the water-swellable dietary fiber dispersion (aqueous phase) of step (b) are mixed to prepare an oil-in-water emulsion. At this time, applying shear using the mixer or the like described above makes the emulsified particles smaller and is preferred. A method of freezing the emulsion after preparation is also effective.

Another component, such as a sweetener, a spice, a salt, a flavor-imparting agent, or a seasoning, other than the components described above can also be added to the emulsion to the extent that the effects of the present invention are not interfered. This addition can be performed before or after step (c).

### Step (d): Dough Preparation

The emulsion prepared in step (c) is mixed with a textured plant protein material and formed into a dough. For mixing, the mixer or the like described above can be used. The textured plant protein material is usually a dried material; thus, water is first absorbed to perform “rehydration” to soften the tissue, and then the textured plant protein material is mixed. However, a textured plant protein material in a dry state may be added to water and mixed, or a partially rehydrated textured plant protein material may be added to water and mixed. In addition, a part of the water can be formed into the oil-in-water emulsion described above.

To change the flavor and/or physical properties, a seasoning of various types, a vegetable, starch, a gelling agent, another dietary fiber, a plant protein material such as powdered soy protein, or the like can be added.

For the amount of each to be used, the amount of the emulsion in the dough is preferably from 10 to 40 wt. % and more preferably from 15 to 30 wt. %. the textured plant protein material is preferably from 5 to 30 wt. % and more preferably from 8 to 20 wt. % in terms of dry matter. The amounts to be used described in steps (a) to (d) above are expressed in wt. % with respect to the weight of the dough.

### Step (e): Molding and Heating

The dough prepared in step (d) is molded into a desired size and shape with a molding machine. This is then subjected to heating. In an embodiment of the present invention, baking heating, steaming heating, boiling heating, frying heating, electromagnetic wave heating, and the like can be appropriately used in combination. In addition, retort heating can also be used. This solidifies the molded dough by heating and stabilizes the shape.

The temperature and time depend on the shape, weight, and heating method but is exemplified by from 180 to 300° C. for 5 to 15 minutes for the baking heating, from 115 to 130° C. for 10 to 60 minutes for the retort heating, and from 75 to 100° C. for 5 to 50 minutes for the steaming heating.

Methylcellulose reversibly forms a gel by heating. Thus, heating and then cooling a food and the like produced using methylcellulose are said to reduce the hardness and deteriorate the texture. However, according to an embodiment of the present invention, the method can provide a meat-like processed food having a texture similar to that of an ordinary livestock meat processed food without using an animal raw material, such as livestock meat and egg white, without reducing the yield upon heating, but maintaining the hardness upon cooling.

### EXAMPLES

The present invention will be explained by describing examples below. The following parts are parts by weight and % is wt. %.

### Example 1: Study with Bamboo Fiber

To 3.2 parts of rapeseed oil. 1.0 parts of methylcellulose (MCE100TS available from Shin-Etsu Chemical Co., Ltd.) was added. The mixture was stirred in a robot coupe, and an oil phase dispersion was formed. Meanwhile, 1.0 parts of bamboo fiber (BAF90 available from Rettenmaier, average fiber length 80 μm, water absorption rate 4.5 times) was added to 13.0 parts of ice-water. The mixture was stirred, and an aqueous phase dispersion was formed. The oil phase dispersion and the aqueous phase dispersion were mixed and stirred to produce an oil-in-water emulsion A. To the total amount of the emulsion A. 3.3 parts of a textured soy protein material B (Apex 650 available from Fuji Oil Co., Ltd., granular shape) rehydrated with 13.2 parts of water. 9.0 parts of a textured soy protein material C (Apex 350 available from Fuji Oil Co., Ltd., granular shape) rehydrated with 22.5 parts of water. 3.5 parts of a textured soy protein material D (Apex 950 available from Fuji Oil Co., Ltd., flat shape) rehydrated with 8.8 parts of water. 10.0 parts of a plant oil and/or fat that is solid at ordinary temperature (Unishort MJ available from Fuji Oil Co., Ltd.), 8.7 parts of a seasoning and a spice, and 2.0 parts of a pregelatinized starch (Matsutani Pine Soft B available from Matsutani Chemical Industry Co., Ltd.) were added. The mixture was stirred with a Kenwood mixer for 3 minutes, and a dough was prepared.

The dough was punched and molded into a 70-g piece using an automatic molding machine (GM-D) available from Nippon Career Industry and then baked by heating at 300° C. for 6 minutes using a convection oven (SCC WE 101 available from Rational Japan Co., Ltd.) to produce a hamburger-like food. The detailed formulation is shown in Table 1, and the addition order of the fibers is shown in Table 2 (Table 2, Procedure X1).

### Comparative Example 1: Addition During Dough Preparation

To 3.2 parts of rapeseed oil. 1.0 part of methylcellulose was added, and the mixture was stirred in a robot coupe. Then. 13.0 parts of ice water was added, and then the mixture was further stirred to produce an oil-in-water emulsion A. To the total amount of the emulsion A, 1.0 part of bamboo fiber was added, and in the same manner as in Example 1, various rehydrated textured soy protein materials, a plant oil and/or fat, a seasoning and a perfume, and a pregelatinized starch were added, the mixture was stirred with a Kenwood mixer to form a dough, and then the dough was molded to produce a hamburger-like food. (Table 2, Procedure X2)

### Comparative Example 2: Addition of Powder Mixture to Oil and/or Fat

A powder mixture of 1.0 part of methylcellulose and 1.0 part of bamboo fiber was added to 3.2 parts of rapeseed oil, and the mixture was stirred in a robot coupe. Then, 13.0 parts of ice water were added, and then the mixture was stirred to produce an oil-in-water emulsion A. To the total amount of the emulsion A, in the same manner as in Example 1, various rehydrated textured soy protein materials, a plant oil and/or fat, a seasoning and a perfume, and a pregelatinized starch were added, the mixture was stirred with a Kenwood mixer to form a dough, and then the dough was then molded to produce a hamburger-like food. (Table 2, Addition order Y)

### Comparative Example 3: Addition of Powder Mixture to Water

A powder mixture of 1.0 part of methylcellulose and 1.0 part of bamboo fiber was added to 13.0 parts of ice water, and the mixture was stirred in a robot coupe. Then, 3.2 parts of rapeseed oil were added, and the mixture was stirred to produce an oil-in-water emulsion A. To the total amount of the emulsion A, in the same manner as in Example 1, various rehydrated textured soy protein materials, a plant oil and/or fat, a seasoning and a perfume, and a pregelatinized starch were added, the mixture was stirred with a Kenwood mixer to form a dough, and then the dough was then molded to produce a hamburger-like food. (Table 2, Addition Order Z)

### Example 2, Comparative Examples 4 to 6: Study with Citrus Fiber

The bamboo fiber was replaced by citrus fiber (Herbacel AQ Plus CF-D/100 available from DSP Gokyo Food & Chemical Co., Ltd., water absorption rate 40 times), and hamburger-like foods were prepared in the same manner as in Example 1 and Comparative Examples 1 to 3.

### Comparative Example 7: No Fiber Addition

A hamburger-like food was prepared in the same manner as in Example 1 except for the bamboo fiber in the formulation of Example 1. (Table 2, Addition order X0)

TABLE 1
Study of Addition Order

| | | | | | | | Com- | Com- | Com- | | Com- | Com- | Com- | Com- |
|---|---|---|---|---|---|---|---|---|---|---|---|---|---|---|
| | | | | | | | par- | par- | par- | | par- | par- | par- | par- |
| | | | | | | | ative | ative | ative | | ative | ative | ative | ative |
| | | | | | | Exam- | Exam- | Exam- | Exam- | Exam- | Exam- | Exam- | Exam- | Exam- |
| | | | | | | ple 1 | ple 1 | ple 2 | ple 3 | ple 2 | ple 4 | ple 5 | ple 6 | ple 7 |
| Formu- | (wt. %) | | | Addition | | X1 | X2 | Y | Z | X1 | X2 | Y | Z | X0 |
| lation | | | | order (see | | | | | | | | | | |
| | | | | Table 2) | | | | | | | | | | |
| | Methyl- | | | Methyl- | | 1.0 | ← | ← | ← | ← | ← | ← | ← | ← |
| | cellulose | | | cellulose | | | | | | | | | | |
| | emulsion | | {open oversize brace} | Ice water | {open oversize brace} | 13.0 | ← | ← | ← | ← | ← | ← | ← | ← |
| | curd | | | Rapeseed | | 3.2 | ← | ← | ← | ← | ← | ← | ← | ← |
| | emulsion | | | oil | | | | | | | | | | |
| | A | | | Bamboo | | 1.0 | | 1.0 | 1.0 | | | | | |
| | | | | Fiber | | | | | | | | | | |
| | | | | BAF90 | | | | | | | | | | |
| | | | | Herbacel | | | | | | 1.0 | | 1.0 | 1.0 | |
| | | | | AQ Plus | | | | | | | | | | |
| | Rehydrated | B | | APEX 650 | | 3.3 | ← | ← | ← | ← | ← | ← | ← | ← |
| | granular soy | | | Rehydration | | 13.2 | ← | ← | ← | ← | ← | ← | ← | ← |
| | protein | | {open oversize bracket} | | {open oversize bracket} | | | | | | | | | |
| | product | | | water | | | | | | | | | | |
| | | C | | APEX 350 | | 9.0 | ← | ← | ← | ← | ← | ← | ← | ← |
| | | | {open oversize bracket} | Rehydration | {open oversize bracket} | 22.5 | ← | ← | ← | ← | ← | ← | ← | ← |
| | | | | water | | | | | | | | | | |
| | | D | | APEX 950 | | 3.5 | ← | ← | ← | ← | ← | ← | ← | ← |
| | | | {open oversize bracket} | Rehydration | {open oversize bracket} | 8.8 | ← | ← | ← | ← | ← | ← | ← | ← |
| | | | | water | | | | | | | | | | |
| | Other | | | Bamboo | | | 1.0 | | | | | | | |
| | ingredients | | | Fiber | | | | | | | | | | |
| | | | | BAF90 | | | | | | | | | | |
| | | | | Herbacel | | | | | | | 1.0 | | | |
| | | | | AQ Plus | | | | | | | | | | |
| | | | | Solid fat | | 10.0 | ← | ← | ← | ← | ← | ← | ← | ← |
| | | | | Pregela- | | 2.0 | ← | ← | ← | ← | ← | ← | ← | ← |
| | | | | tinized | | | | | | | | | | |
| | | | | starch | | | | | | | | | | |
| | | | | Seasoning | | 8.7 | ← | ← | ← | ← | ← | ← | ← | ← |
| | | | | and spice | | | | | | | | | | |
| Total | | | | | | 99.2 | 99.2 | 99.2 | 99.2 | 99.2 | 99.2 | 99.2 | 99.2 | 98.2 |
| Evalu- | | | | Heating | | 74.7 | 75.9 | 75.2 | 76.0 | 79.7 | 79.0 | 78.5 | 78.2 | 70.9 |
| ation | | | | yield | | | | | | | | | | |
| | | | | (wt. %) | | | | | | | | | | |
| | Texture | | | Hardness | | 5 | 2 | 2 | 1 | 4 | 2 | 2 | 2 | 1 |
| | | | | after | | | | | | | | | | |
| | | | | heating | | | | | | | | | | |
| | | | | Meat-like | | 5 | 2 | 2 | 1 | 4 | 2 | 2 | 2 | 1 |
| | | | | texture | | | | | | | | | | |
| | | | | after | | | | | | | | | | |
| | | | | heating | | | | | | | | | | |
| | | | | Hardness | | 5 | 2 | 2 | 2 | 4 | 2 | 2 | 1 | 1 |
| | | | | after | | | | | | | | | | |
| | | | | allowing | | | | | | | | | | |
| | | | | to cool | | | | | | | | | | |
| | | | | Meat-like | | 5 | 2 | 2 | 2 | 4 | 2 | 2 | 1 | 1 |
| | | | | texture | | | | | | | | | | |
| | | | | after | | | | | | | | | | |
| | | | | allowing | | | | | | | | | | |
| | | | | to cool | | | | | | | | | | |
| | | | | Overall | | 5 | 2 | 2 | 2 | 4 | 2 | 2 | 2 | 1 |
| | | | | evaluation | | Ac- | Unac- | Unac- | Unac- | Ac- | Unac- | Unac- | Unac- | Unac- |
| | | | | | | cept- | cept- | cept- | cept- | cept- | cept- | cept- | cept- | cept- |
| | | | | | | able | able | able | able | able | able | able | able | able |

TABLE 2
Addition Order Abbreviations

| Abbreviations | Addition order |
|---|---|
| X0 | Water was added to the oil and/or fat in which |
| | methylcellulose (MC) was dispersed, and the mixture |
| | was emulsified. |
| X1 | Water in which fiber was dispersed was added to the oil |
| | and/or fat in which MC was dispersed, and the mixture |
| | was emulsified. |
| X2 | Water was added to the oil and/or fat in which MC was |
| | dispersed, the mixture was emulsified, then the fiber was |
| | added to the dough and dispersed. |
| Y | Water was added to the oil and/or fat in which the powder |
| | mixture of MC and the fiber was dispersed, and the |
| | mixture was emulsified. |
| Z | The oil and/or fat was added to water in which the powder |
| | mixture of MC and the fiber was dispersed, and the |
| | mixture was emulsified. |

### Evaluation

The weight of each molded dough was measured before and after the molded dough was heated, and a value obtained by dividing the weight after the molded dough was heated by the weight before heating the molded dough was heated was expressed as the heating yield (wt. %). In addition, sensory evaluation was performed at two points: when a product temperature was about from 50 to 60° C. immediately after the molded dough was heated and baked (after the molded dough was heated); and when a product temperature was about from 30 to 40° C. after the product was allowed to stand at ordinary temperature for 20 minutes or more (after the product was allowed to cool); each according to the following criteria.

### Sensory Evaluation Criteria

The sensory evaluation was performed by five skilled panelists, and the livestock meat processed food-likeness, in particular, the hamburger-like texture, was comprehensively evaluated and determined by discussion. A product with a score of 3 or greater in each criterion was determined to be acceptable.
Hardness
   The initial hardness in the mouth was defined as follows.
   5: Sufficiently hard initial bite
   4: Hard initial bite
   3: Slightly soft initial bite
   2: Soft initial bite
   1: Very soft initial bite
Meat-like texture

Livestock meat patty (hamburger)-like loosening feeling perceived from the middle to the latter half of chewing was defined as meat-like texture as follows.
5. Exhibiting almost no stickiness, exhibiting strong loosening feeling and being rich in granular feeling of meat
4. Exhibiting less stickiness, exhibiting loose feeling and also granular feeling of meat
3. Exhibiting slight stickiness and slightly weak loosening feeling
2. Exhibiting strong stickiness and weak loosening feeling
1. Exhibiting very strong stickiness and weak loosening feeling
Overall evaluation
5: Comparable to hamburgers of livestock meat and particularly good
4: Good as a hamburger-like food without problem
3: Slightly inferior but within the range of hamburger-like foods
2: Discomfort as a hamburger-like food
1: Unsuitable as a hamburger-like food

As shown in Table 1, hamburger-like foods with good texture also after being allowed to cool were able to be prepared only in Examples 1 and 2, in which the emulsion was prepared by mixing the aqueous phase prepared by adding the bamboo fiber or the citrus fiber (Herbacel) with the oil and/or fat (oil phase) prepared by dispersing methylcellulose. On the other hand, meat-like texture could not be obtained not only after the products were allowed to cool but also immediately after the products were baked in all of Comparative Examples 1 and 4, in which the fiber was added simultaneously with the other ingredients (addition order X2), and Comparative Examples 2, 3, 5, and 6, in which the fiber and methylcellulose were mixed in a powder state in advance and then added to the oil phase (addition order Y) or the aqueous phase (addition order Z). Comparative Example 7, in which no fiber was added (addition order X0), exhibited even worse physical properties.

### Examples 3 to 7 and Comparative Examples 8 to 12: Study of Various Fibers and Addition Order

The bamboo fiber in the formulations of Example 1 and Comparative Example 1 was replaced by a lemon fiber (Lemon Fiber 100FG available from the Torigoe Co., Ltd., water absorption rate 30 times), and hamburger-like foods were prepared in the same manner (Example 3 and Comparative Example 8). Furthermore, the bamboo fiber in the formulations of Example 1 and Comparative Example 1 was replaced by a fiber of the following, and hamburger-like foods were prepared in the same manner: a citrus fiber (Citri-Fi 100FG available from the Torigoe Co., Ltd., water absorption rate 20 times) (Example 4 and Comparative Example 9);
an apple fiber (Apple AF401 available from Rettenmaier, water absorption rate 8 times) (Example 5 and Comparative Example 10);
an oat fiber (Oat Fiber HF200 available from Rettenmaier, water absorption rate 10 times) (Example 6 and Comparative Example 11); and
a pea fiber (Pea EF150 available from Rettenmaier, water absorption rate 14 times) (Example 7 and Comparative Example 12).

### Comparative Example 13

The bamboo fiber in the formulation of Example 1 was replaced by a water-soluble polysaccharide (Water-Soluble Soybean Polysaccharide Soyafibe-S-DN available from Fuji Oil Co., Ltd., water absorption rate not measurable), and a hamburger-like food was prepared in the same manner.

TABLE 3
Study of Various fibers and Addition Order

| | | | | | | | | | | | Com- | Com- | Com- | Com- | Com- | Com- |
|---|---|---|---|---|---|---|---|---|---|---|---|---|---|---|---|---|
| | | | | | | | | | | | par- | par- | par- | par- | par- | par- |
| | | | | | | Ex- | Ex- | Ex- | Ex- | Ex- | ative | ative | ative | ative | ative | ative |
| | | | | | | am- | am- | am- | am- | am- | Exam- | Exam- | Exam- | Exam- | Exam- | Exam- |
| | | | | | | ple 3 | ple 4 | ple 5 | ple 6 | ple 7 | ple 8 | ple 9 | ple 10 | ple 11 | ple 12 | ple 13 |
| For- | (wt. | | | Addi- | | X1 | X1 | X1 | X1 | X1 | X2 | X2 | X2 | X2 | X2 | X1 |
| mu- | %) | | | tion | | | | | | | | | | | | |
| la- | | | | order | | | | | | | | | | | | |
| tion | | | | (see | | | | | | | | | | | | |
| | | | | Table | | | | | | | | | | | | |
| | | | | 2) | | | | | | | | | | | | |
| | | | | Meth- | | 1.0 | ← | ← | ← | ← | ← | ← | ← | ← | ← | ← |
| | | | | yl- | | | | | | | | | | | | |
| | | | | cellu- | | | | | | | | | | | | |
| | | | | lose | | | | | | | | | | | | |
| | | | | Ice | | 13.0 | ← | ← | ← | ← | ← | ← | ← | ← | ← | ← |
| | | | | water | | | | | | | | | | | | |
| | | | | Rape- | | 3.2 | ← | ← | ← | ← | ← | ← | ← | ← | ← | ← |
| | | | {open oversize brace} | seed | {open oversize brace} | | | | | | | | | | | |
| | | | | oil | | | | | | | | | | | | |
| | Meth- | | | Lemon | | 1.0 | | | | | | | | | | |
| | yl- | | | Fiber | | | | | | | | | | | | |
| | cellu- | | | 100FG | | | | | | | | | | | | |
| | lose | | | Citri-Fi | | | 1.0 | | | | | | | | | |
| | emul- | | | 100FG | | | | | | | | | | | | |
| | sion | | | Apple | | | | 1.0 | | | | | | | | |
| | curd | | | AF401 | | | | | | | | | | | | |
| | emul- | | | Oat | | | | | 1.0 | | | | | | | |
| | sion A | | | fiber | | | | | | | | | | | | |
| | | | | Pea | | | | | | 1.0 | | | | | | |
| | | | | EF150 | | | | | | | | | | | | |
| | | | | Water- | | | | | | | | | | | | 1.0 |
| | | | | soluble | | | | | | | | | | | | |
| | | | | soybean | | | | | | | | | | | | |
| | | | | polysac- | | | | | | | | | | | | |
| | | | | charide | | | | | | | | | | | | |
| | Rehy- | B | | APEX | | 3.3 | ← | ← | ← | ← | ← | ← | ← | ← | ← | ← |
| | drated | | | 650 | | | | | | | | | | | | |
| | granular | | {open oversize bracket} | Rehy- | {open oversize bracket} | 13.2 | ← | ← | ← | ← | ← | ← | ← | ← | ← | ← |
| | soy | | | dration | | | | | | | | | | | | |
| | protein | | | water | | | | | | | | | | | | |
| | product | C | | APEX | | 9.0 | ← | ← | ← | ← | ← | ← | ← | ← | ← | ← |
| | | | | 350 | | | | | | | | | | | | |
| | | | {open oversize bracket} | Rehy- | {open oversize bracket} | 22.5 | ← | ← | ← | ← | ← | ← | ← | ← | ← | ← |
| | | | | dration | | | | | | | | | | | | |
| | | | | water | | | | | | | | | | | | |
| | | D | | APEX | | 3.5 | ← | ← | ← | ← | ← | ← | ← | ← | ← | ← |
| | | | | 950 | | | | | | | | | | | | |
| | | | {open oversize bracket} | Rehy- | {open oversize bracket} | 8.8 | ← | ← | ← | ← | ← | ← | ← | ← | ← | ← |
| | | | | dration | | | | | | | | | | | | |
| | | | | water | | | | | | | | | | | | |
| | Other | | | Lemon | | | | | | | 1.0 | | | | | |
| | ingre- | | | Fiber | | | | | | | | | | | | |
| | dients | | | 100FG | | | | | | | | | | | | |
| | | | | Citri-Fi | | | | | | | | 1.0 | | | | |
| | | | | 100FG | | | | | | | | | | | | |
| | | | | Apple | | | | | | | | | 1.0 | | | |
| | | | | AF401 | | | | | | | | | | | | |
| | | | | Oat | | | | | | | | | | 1.0 | | |
| | | | | Fiber | | | | | | | | | | | | |
| | | | | HF200 | | | | | | | | | | | | |
| | | | | Pea | | | | | | | | | | | 1.0 | |
| | | | | EF150 | | | | | | | | | | | | |
| | | | | Solid | | 10.0 | ← | ← | ← | ← | ← | ← | ← | ← | ← | ← |
| | | | | fat | | | | | | | | | | | | |
| | | | | Pregela- | | 2.0 | ← | ← | ← | ← | ← | ← | ← | ← | ← | ← |
| | | | | tinized | | | | | | | | | | | | |
| | | | | starch | | | | | | | | | | | | |
| | | | | Sea- | | 8.7 | ← | ← | ← | ← | ← | ← | ← | ← | ← | ← |
| | | | | soning | | | | | | | | | | | | |
| | | | | and | | | | | | | | | | | | |
| | | | | spice | | | | | | | | | | | | |
| Total | | | | | | 99.2 | 99.2 | 99.2 | 99.2 | 99.2 | 99.2 | 99.2 | 99.2 | 99.2 | 99.2 | 99.2 |
| Evalu- | | | | Heating | | 73.6 | 75.0 | 74.9 | 73.6 | 74.7 | 76.5 | 76.4 | 75.5 | 75.1 | 74.8 | 75.3 |
| ation | | | | yield | | | | | | | | | | | | |
| | | | | (wt. %) | | | | | | | | | | | | |
| | Texture | | | Hard- | | 4 | 4 | 3 | 4 | 3 | 2 | 2 | 2 | 1 | 1 | 2 |
| | | | | ness | | | | | | | | | | | | |
| | | | | after | | | | | | | | | | | | |
| | | | | heating | | | | | | | | | | | | |
| | | | | Meat- | | 4 | 4 | 3 | 4 | 3 | 2 | 2 | 2 | 1 | 1 | 2 |
| | | | | like | | | | | | | | | | | | |
| | | | | texture | | | | | | | | | | | | |
| | | | | after | | | | | | | | | | | | |
| | | | | heating | | | | | | | | | | | | |
| | | | | Hard- | | 4 | 4 | 3 | 5 | 3 | 2 | 2 | 1 | 2 | 1 | 2 |
| | | | | ness | | | | | | | | | | | | |
| | | | | after al- | | | | | | | | | | | | |
| | | | | lowing | | | | | | | | | | | | |
| | | | | to cool | | | | | | | | | | | | |
| | | | | Meat- | | 4 | 4 | 3 | 5 | 3 | 2 | 2 | 1 | 2 | 1 | 2 |
| | | | | like | | | | | | | | | | | | |
| | | | | texture | | | | | | | | | | | | |
| | | | | after al- | | | | | | | | | | | | |
| | | | | lowing | | | | | | | | | | | | |
| | | | | to cool | | | | | | | | | | | | |
| | | | | Overall | | 4 | 4 | 3 | 5 | 3 | 2 | 2 | 2 | 2 | 1 | 2 |
| | | | | evalu- | | Ac- | Ac- | Ac- | Ac- | Ac- | Unac- | Unac- | Unac- | Unac- | Unac- | Unac- |
| | | | | ation | | cept- | cept- | cept- | cept- | cept- | cept- | cept- | cept- | cept- | cept- | cept- |
| | | | | | | able | able | able | able | able | able | able | able | able | able | able |

The results are shown in Table 3. All of the lemon fiber, citrus fiber, apple fiber, oat fiber, and pea fiber of Examples 3 to 7 showed good effects (X1). On the other hand, in all of Comparative Examples 8 to 12, in which the fiber was added not with the emulsion curd but simultaneously with the other ingredients (X2), the hamburger-like food was soft in terms of physical properties after being allowed to cool and was poorly evaluated. In addition, Comparative Example 13, which is the water-soluble polysaccharide, was similarly poorly evaluated (X1).

### Examples 8 to 11: Study of Addition Amount

The blending amount of the bamboo fiber in the formulation of Example 1 was changed as shown in Table 4, and Examples 8 to 11 were performed. The effect was observed under all conditions, but in particular, the results were good from Example 9 blended with 0.5 wt. % of the bamboo fiber to Example 11 blended with 3 wt. % of the bamboo fiber.

TABLE 4
Study of Addition Amount

| | | | | | | Example 8 | Example 9 | Example 1 | Example 10 | Example 11 |
|---|---|---|---|---|---|---|---|---|---|---|
| Formulation | (wt. %) | | | Addition order | | X1 | X1 | X1 | X1 | X1 |
| | | | | (see Table 2) | | | | | | |
| | Methylcellulose | | | Methylcellulose | | 1.0 | ← | ← | ← | ← |
| | emulsion curd | | {open oversize brace} | Ice water | {open oversize brace} | 13.0 | ← | ← | ← | ← |
| | emulsion A | | | Rapeseed oil | | 3.2 | ← | ← | ← | ← |
| | | | | Bamboo Fiber | | 0.1 | 0.5 | 1.0 | 2 | 3 |
| | | | | BAF90 | | | | | | |
| | Rehydrated | B | | APEX 650 | | 3.3 | ← | ← | ← | ← |
| | granular soy | | {open oversize bracket} | Rehydration | {open oversize bracket} | 13.2 | ← | ← | ← | ← |
| | protein | | | water | | | | | | |
| | product | C | | APEX 350 | | 9.0 | ← | ← | ← | ← |
| | | | {open oversize bracket} | Rehydration | {open oversize bracket} | 22.5 | ← | ← | ← | ← |
| | | | | water | | | | | | |
| | | D | | APEX 950 | | 3.5 | ← | ← | ← | ← |
| | | | {open oversize bracket} | Rehydration | {open oversize bracket} | 8.8 | ← | ← | ← | ← |
| | | | | water | | | | | | |
| | Other | | | Solid fat | | 10.0 | ← | ← | ← | ← |
| | ingredients | | | Pregelatinized | | 2.0 | ← | ← | ← | ← |
| | | | | starch | | | | | | |
| | | | | Seasoning | | 8.7 | ← | ← | ← | ← |
| | | | | and spice | | | | | | |
| Total | | | | | | 98.3 | 98.7 | 99.2 | 100.2 | 101.2 |
| Evaluation | | | | Heating yield | | 76.6 | 76.9 | 74.7 | 77.0 | 78.3 |
| | | | | (wt. %) | | | | | | |
| | Texture | | | Hardness after | | 3 | 4 | 5 | 5 | 4 |
| | | | | heating | | | | | | |
| | | | | Meat-like | | 3 | 4 | 5 | 5 | 4 |
| | | | | texture after | | | | | | |
| | | | | heating | | | | | | |
| | | | | Hardness after | | 3 | 4 | 5 | 5 | 4 |
| | | | | allowing to cool | | | | | | |
| | | | | Meat-like | | 3 | 4 | 5 | 5 | 5 |
| | | | | texture after | | | | | | |
| | | | | allowing to cool | | | | | | |
| | | | | Overall | | 3 | 4 | 5 | 5 | 4 |
| | | | | evaluation | | Acceptable | Acceptable | Acceptable | Acceptable | Acceptable |

### INDUSTRIAL APPLICABILITY

Using an embodiment of the present invention enables production of a meat-like processed food that maintains a good texture also after being cooled without using an animal raw material.

1. A method for producing a meat-like processed food, the method comprising:
(a) dispersing methylcellulose in an oil and/or fat to obtain a methylcellulose dispersion;
(b) swelling and dispersing a water-swellable dietary fiber in water to obtain a water-swellable dietary fiber dispersion;
(c) mixing the methylcellulose dispersion and the water-swellable dietary fiber dispersion to prepare an oil-in-water emulsion;
(d) mixing a textured plant protein material with the oil-in-water emulsion to prepare a dough; and
(e) molding the dough prepared in (d), and then heating the molded dough to produce a meat-like processed food.

2. The method for producing a meat-like processed food according to claim 1, wherein the dough comprises an oil-in-water emulsion gel comprising methylcellulose.

3. The method for producing a meat-like processed food according to claim 1, wherein the amount of the water-swellable dietary fiber in the dough is 0.05 to 5 wt. %.

4. The method for producing a meat-like processed food according to claim 1, wherein a water absorption amount of the water-swellable dietary fiber is 3 times or more, that is, 3 mL or more per 1 g of the water-swellable dietary fiber.

5. The method for producing a meat-like processed food according to claim 2, wherein the amount of the water-swellable dietary fiber in the dough is 0.05 to 5 wt. %.

6. The method for producing a meat-like processed food according to claim 2, wherein a water absorption amount of the water-swellable dietary fiber is 3 times or more, that is, 3 mL or more per 1 g of the water-swellable dietary fiber.

7. The method for producing a meat-like processed food according to claim 3, wherein a water absorption amount of the water-swellable dietary fiber is 3 times or more, that is, 3 mL or more per 1 g of the water-swellable dietary fiber.

8. The method for producing a meat-like processed food according to claim 5, wherein a water absorption amount of the water-swellable dietary fiber is 3 times or more, that is, 3 mL or more per 1 g of the water-swellable dietary fiber.

9. (canceled)

10. (canceled)

11. A method for producing a meat-like processed food, the method comprising:
(a) dispersing methylcellulose in an oil and/or fat to obtain a methylcellulose dispersion;
(b) swelling and dispersing a water-swellable dietary fiber in water to obtain a water-swellable dietary fiber dispersion;
(c) mixing the methylcellulose dispersion and the water-swellable dietary fiber dispersion to prepare an oil-in-water emulsion;
(d) mixing a textured plant protein material with the oil-in-water emulsion to prepare a dough; and
(e) molding the dough prepared in (d), and then heating the molded dough to produce a meat-like processed food,
wherein the meat-like processed food is free from livestock meat and egg white.

12. The method for producing a meat-like processed food according to claim 1, wherein the dough comprises an oil-in-water emulsion gel comprising methylcellulose, and the meat-like processed food is free from livestock meat and egg white.

13. The method for producing a meat-like processed food according to claim 1, wherein the amount of the water-swellable dietary fiber in the dough is 0.05 to 5 wt. %, and the meat-like processed food is free from livestock meat and egg white.

14. The method for producing a meat-like processed food according to claim 1, wherein a water absorption amount of the water-swellable dietary fiber is 3 times or more, that is, 3 mL or more per 1 g of the water-swellable dietary fiber, and the meat-like processed food is free from livestock meat and egg white.

15. The method for producing a meat-like processed food according to claim 2, wherein the amount of the water-swellable dietary fiber in the dough is 0.05 to 5 wt. %, and the meat-like processed food is free from livestock meat and egg white.

16. The method for producing a meat-like processed food according to claim 2, wherein a water absorption amount of the water-swellable dietary fiber is 3 times or more, that is, 3 mL or more per 1 g of the water-swellable dietary fiber, and the meat-like processed food is free from livestock meat and egg white.

17. The method for producing a meat-like processed food according to claim 3, wherein a water absorption amount of the water-swellable dietary fiber is 3 times or more, that is, 3 mL or more per 1 g of the water-swellable dietary fiber, and the meat-like processed food is free from livestock meat and egg white.

18. The method for producing a meat-like processed food according to claim 5, wherein a water absorption amount of the water-swellable dietary fiber is 3 times or more, that is, 3 mL or more per 1 g of the water-swellable dietary fiber, and the meat-like processed food is free from livestock meat and egg white.

19. A method for improving a yield of a meat-like processed food upon heating, the method comprising:
(a) dispersing methylcellulose in an oil and/or fat to obtain a methylcellulose dispersion;
(b) swelling and dispersing a water-swellable dietary fiber in water to obtain a water-swellable dietary fiber dispersion;
(c) mixing the methylcellulose dispersion and the water-swellable dietary fiber dispersion to prepare an oil-in-water emulsion;
(d) mixing a textured plant protein material with the oil-in-water emulsion to prepare a dough; and
(e) molding the dough prepared in (d), and then heating the molded dough to produce a meat-like processed food.

20. A method for improving a yield of a meat-like processed food upon heating, the method comprising:
(a) dispersing methylcellulose in an oil and/or fat to obtain a methylcellulose dispersion;
(b) swelling and dispersing a water-swellable dietary fiber in water to obtain a water-swellable dietary fiber dispersion;
(c) mixing the methylcellulose dispersion and the water-swellable dietary fiber dispersion to prepare an oil-in-water emulsion;
(d) mixing a textured plant protein material with the oil-in-water emulsion to prepare a dough; and
(e) molding the dough prepared in (d), and then heating the molded dough to produce a meat-like processed food,
wherein the meat-like processed food is free from livestock meat and egg white.
